(19) United States
(12) Patent Application Publication
(10) Pub. No.: US 2007/0288576 A1
(43) Pub. Date: Dec. 13, 2007

(54) Disambiguating Responses to Questions Within Electronic Messaging Communications

(76) Inventor: Jason J. Illg, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/423,469

(22) Filed: Jun. 12, 2006

(51) Int. Cl. G06F 15/16

(52) U.S. Cl. 709/206

(57) ABSTRACT

Methods, apparatus, and computer program products for disambiguating responses to questions within electronic messaging communications that include identifying within electronic messaging communications a question, rendering on a message graphical user interface (‘GUI’) a response request indicator adjacent to the question within the electronic messaging communications, and providing a response to the identified question by receiving an invocation of the response request indicator. Disambiguating responses to questions within electronic messaging communications may also include rendering on the message GUI the response. Disambiguating responses to questions within electronic messaging communications may also include rendering on the message GUI a response indicator that indicates the presence of the response.

### BACKGROUND OF THE INVENTION

1. Field of the Invention

The field of the invention is data processing, or, more specifically, methods, systems, and products for disambiguating responses to questions within electronic messaging communications.

2. Description of Related Art

Over the past several years, instant messaging communications and email messaging communications have taken on important roles in advancing communications between users of computer systems. Instant messaging and email messages enable convenient environments for users to share information and work collaboratively for both vocational and avocational pursuits. Instant messaging and email messages offer distinct advantages over conventional communications methods such as paper-based mail and telephone calls because instant messaging and email messaging communications are typically faster and cheaper than conventional methods of communication.

During communications afforded by both instant messaging and email messaging, users may promulgate ideas or pose questions to other users. When responding to questions via instant messaging or email communications, users receiving a response often have trouble disambiguating which question in the communications induced a particular response. Consider, for example, the following chat messages from a chat room:

<User1> Should I talk to development about it?

<User1> Should I talk to the test team?

<User2> Yes.

In the exemplary chat messaging communications above, ‘User1’ has difficulty determining which question prompted ‘User2’ to respond with ‘Yes.’ Moreover, other users joined to the chat room will also have difficulty discerning which question prompted the response of ‘User2.’ The ambiguity described above is common in chat messaging communications because of the nature of chat messaging and disparate rates at which users type and read text.

### SUMMARY OF THE INVENTION

Methods, apparatus, and computer program products for disambiguating responses to questions within electronic messaging communications that include identifying within electronic messaging communications a question, rendering on a message graphical user interface (‘GUI’) a response request indicator adjacent to the question within the electronic messaging communications, and providing a response to the identified question by receiving an invocation of the response request indicator. Disambiguating responses to questions within electronic messaging communications may also include rendering on the message GUI the response. Disambiguating responses to questions within electronic messaging communications may also include rendering on the message GUI a response indicator that indicates the presence of the response.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for disambiguating responses to questions within electronic messaging communications according to embodiments of the present invention.

FIG. 2 sets forth a block diagram of automated computing machinery comprising an exemplary computer useful in disambiguating responses to questions within electronic messaging communications according to embodiments of the present invention.

FIG. 3 sets forth a flow chart illustrating an exemplary method for disambiguating responses to questions within electronic messaging communications according to embodiments of the present invention.

FIG. 4 sets forth a flow chart illustrating a further exemplary method for disambiguating responses to questions within electronic messaging communications according to embodiments of the present invention.

FIG. 5 sets forth a flow chart illustrating a further exemplary method for disambiguating responses to questions within electronic messaging communications according to embodiments of the present invention.

FIG. 6 sets forth a flow chart illustrating a further exemplary method for disambiguating responses to questions within electronic messaging communications according to embodiments of the present invention.

FIG. 7 sets forth a flow chart illustrating a further exemplary method for disambiguating responses to questions within electronic messaging communications according to embodiments of the present invention.

FIG. 8 sets forth a flow chart illustrating a further exemplary method for disambiguating responses to questions within electronic messaging communications according to embodiments of the present invention.

### DETAILED DESCRIPTION OF EXEMPLARY EMBODIMENTS

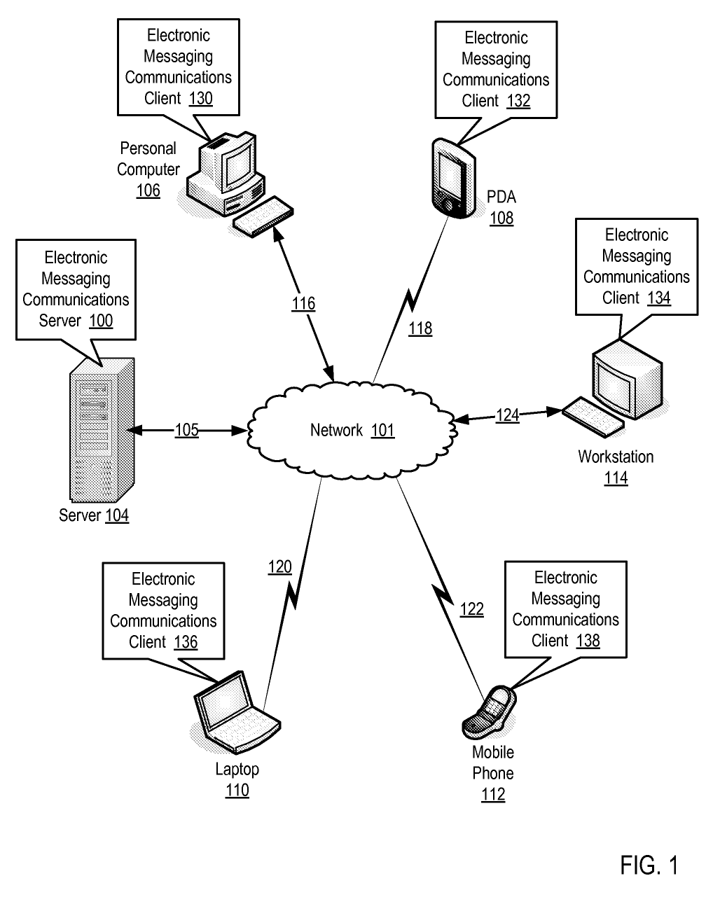

Exemplary methods, systems, and products for disambiguating responses to questions within electronic messaging communications according to embodiments of the present invention are described with reference to the accompanying drawings, beginning with FIG. 1. FIG. 1 sets forth a network diagram illustrating an exemplary system for disambiguating responses to questions within electronic messaging communications according to embodiments of the present invention. The system of FIG. 1 operates generally to disambiguate responses to questions within electronic messaging communications according to embodiments of the present invention by identifying within electronic messaging communications a question, rendering on a message graphical user interface (‘GUI’) a response request indicator adjacent to the question within the electronic messaging communications, and providing a response to the identified question by receiving an invocation of the response request indicator.

Electronic messaging communications are a collection of related electronic messages employed for user communication. Electronic messaging communications are electronic representations of a conversation among users. An example of electronic messaging communications may include chat messages exchanged in a chat room. Chat messages provide users with real-time communications. A user joins a chat room to indicate the user's presence to other users joined to the chat room and to receive chat messages. Chat messages posted by a user to a chat room are instantly visible to all other users joined in the chat room. All the chat messages exchanged in a chat room form a conversation among the users joined to the chat room.

Another example of electronic messaging communications may include the email messages of a thread of emails. Similar to chat messages, email messages provide users with the ability to communicate with one another. Unlike chat messages, however, email messages typically do not provide users with real-time communication. The senders of email have no way of knowing whether the email recipient is available to immediately respond. In a typical email messaging communications, a user creates an email message and sends the email to another user. The recipient of the email may then respond to the received email by creating a reply email message. In turn, the recipient of the reply email message may respond with another reply email message and so on. The original emails and the subsequent reply email messages resulting from the original email message form a conversation among the users often referred to as a ‘thread of emails.’

The exemplary system of FIG. 1 includes several devices (106, 108, 110, 112, 114) having installed upon them electronic messaging communications clients (130, 132, 134, 136, 138). In the example of FIG. 1, the personal computer (106) has installed upon it the electronic messaging communications client (130). The personal digital assistant (108) has installed upon it the electronic messaging communications client (132). The workstation (114) has installed upon it the electronic messaging communications client (134). The laptop (110) has installed upon it the electronic messaging communications client (136). The network-enabled mobile phone (112) has installed upon it the electronic messaging communications client (138).

Each electronic messaging communications client (130, 132, 134, 136, 138) is a set of computer program instructions configured to create, send, and receive users' electronic messages and to provide a user interface for users to create and access electronic messages. An electronic messaging communications client may be implemented, for example, as a chat client or an email client. The electronic messaging communications client may be a standalone computer software application or a plug-in to another software application such as, for example, a dynamically linked library (‘DLL’), a Java applet, and other plug-ins as will occur to those of skill in the art. To send electronic messages, a user typically provides the message text through the user interface of a client and operates a button on the user interface to instruct the client to transmit the message to the recipient. The manner in which users receive electronic messages typically depends on whether the client is a chat client or an email client. Using a chat client, the user typically receives the electronic messages immediately after the sender transmits the message because the chat client renders the messages on the user interface for the user to view and respond. Using an email client, the user typically receives an indication that the email client has received the electronic messages that are available for the user to view and respond to at the user's leisure.

In the example of FIG. 1, each electronic messaging communications client (130, 132, 134, 136, 138) includes a set of computer programs instructions configured to disambiguate responses to questions within electronic messaging communications according to embodiments of the present invention. Each electronic messaging communications client (130, 132, 134, 136, 138) operates generally to disambiguate responses to questions within electronic messaging communications according to embodiments of the present invention by identifying within electronic messaging communications a question, rendering on a message GUI a response request indicator adjacent to the question within the electronic messaging communications, and providing a response to the identified question by receiving an invocation of the response request indicator. Examples of electronic messaging communications clients that may be improved for disambiguating responses to questions within electronic messaging communications according to embodiments of the present invention may include the Yahoo!®, Messenger, the MSN® Messenger, the AOL® Instant Messenger, and so on.

The exemplary system of FIG. 1 includes a server (104) having installed upon it an electronic messaging communications server (100) such as, for example, a chat server or an email server. The electronic messaging communications server (100) is a set of computer program instructions configured to administer the exchange of electronic messages between the electronic messaging communications clients (130, 132, 134, 136, 138). The electronic messaging communications server (100) of FIG. 1 stores the electronic messages received from the clients (130, 132, 134, 136, 138) and provides the clients (130, 132, 134, 136, 138) access to the stored electronic messages. Example of electronic messaging communications servers useful for disambiguating responses to questions within electronic messaging communications according to embodiments of the present invention may include Lotus® Sametime, RealChat™, the DBabble Chat Server and Instant Messaging Software, Microsoft Exchange Server, XMail, and so on.

In the exemplary system of FIG. 1, the electronic messaging communications clients (130, 132, 134, 136, 138) exchange electronic messages with each other through the electronic messaging communications server (100). The clients (130, 132, 134, 136, 138) and server (100) may exchange electronic messages using data communications protocols such as, for example, Jabber, Internet Relay Chat (‘IRC’), Sametime, Simple Mail Transfer Protocol (‘SMTP’), Post Office Protocol (‘POP3’), and any other data communication protocols as will occur to those of skill in the art. Although the electronic messaging communications clients (130, 132, 134, 136, 138) of FIG. 1 are described as exchanging electronic messages through electronic messaging communications server (100), such a depiction is for explanation and not for limitation. The electronic messaging communications clients may exchange electronic messages directly with other clients.

The various devices (100, 106, 108, 110, 112, 114) on which the electronic messaging communications clients (130, 132, 134, 136, 138) and the electronic messaging communications server (100) are installed connect for data communication through network (101). In the example of FIG. 1, the server (104) connects to the network (101) through wireline connection (105). The personal computer (106) connects to the network (101) through wireline connection (116). The personal digital assistant (‘PDA’) connects to the network (101) through wireless connection (118). The laptop (110) connects to the network (101) through wireless connection (120). The network-enabled mobile phone (112) connects to the network (101) through wireless connection (122). The workstation (114) connects to the network (101) through wireline connection (124).

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example the Transmission Control Protocol (‘TCP’), the Internet Protocol (‘IP’), the HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 1.

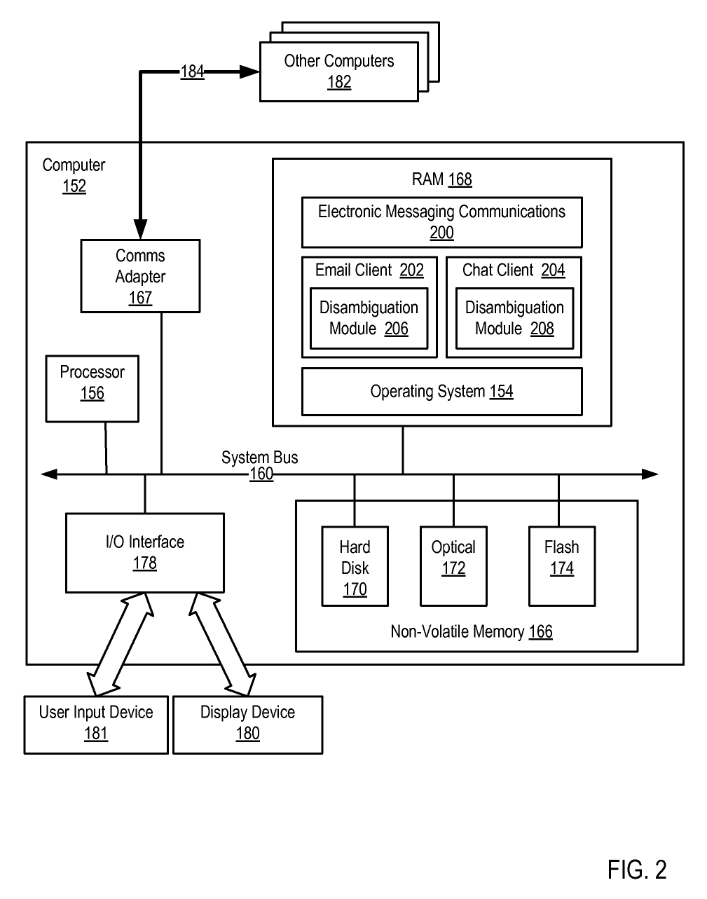

Disambiguating responses to questions within electronic messaging communications in accordance with the present invention is generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery comprising an exemplary computer (152) useful in disambiguating responses to questions within electronic messaging communications according to embodiments of the present invention. The computer (152) of FIG. 2 includes at least one computer processor (156) or ‘CPU’ as well as random access memory (168) (‘RAM’) which is connected through a system bus (160) to processor (156) and to other components of the computer.

Stored in RAM (168) is electronic messaging communications (200). The electronic messaging communications (200) is a collection of related electronic messages employed for user communication. Electronic messaging communications (200) are electronic representations of a conversation among users such as, for example, the emails of a thread of emails or the chat messages exchanged in a chat room.

Also stored in RAM (168) is an email client (202). The email client (202) is a set of computer program instructions for creating, sending, and receiving users' emails and for providing a user interface for users to create and access emails. The email client (202) includes a disambiguation module (206). The disambiguation module (206) is a set of computer programs instructions configured to disambiguate responses to questions within electronic messaging communications according to embodiments of the present invention. The disambiguation module (206) operates generally to disambiguate responses to questions within electronic messaging communications according to embodiments of the present invention by identifying within electronic messaging communications a question, rendering on a message GUI a response request indicator adjacent to the question within the electronic messaging communications, and providing a response to the identified question by receiving an invocation of the response request indicator.

Also stored in RAM (168) is a chat client (204). The chat client (204) is a set of computer program instructions for creating, sending, and receiving users' chat messages and for providing a user interface for users to create and access chat messages. The chat client (204) includes a disambiguation module (208). Similar to the disambiguation module (206) of the email client (202), the disambiguation module (208) is a set of computer programs instructions configured to disambiguate responses to questions within electronic messaging communications according to embodiments of the present invention. The disambiguation module (208) operates generally to disambiguate responses to questions within electronic messaging communications according to embodiments of the present invention by identifying within electronic messaging communications a question, rendering on a message GUI a response request indicator adjacent to the question within the electronic messaging communications, and providing a response to the identified question by receiving an invocation of the response request indicator.

Also stored in RAM (168) is an operating system (154). Operating systems useful in computers according to embodiments of the present invention include UNIX™, Linux™, Microsoft XP™, AIX™, IBM's i5/OS™, and others as will occur to those of skill in the art. The operating system (154), email client (202), chat client (204), and electronic messaging communications (200) in the example of FIG. 2 are shown in RAM (168), but many components of such software typically are stored in non-volatile memory (166) also.

Computer (152) of FIG. 2 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (184) with other computers (182). Such data communications may be carried out serially through RS-232 connections, through external buses such as the Universal Serial Bus (‘USB’), through data communications networks such as IP networks, and in other ways as will occur to those of skill in the art. Communications adapters implement the hardware level of data communications through which one computer sends data communications to another computer, directly or through a network. Examples of communications adapters useful for disambiguating responses to questions within electronic messaging communications according to embodiments of the present invention include modems for wired dial-up communications, Ethernet (IEEE 802.3) adapters for wired network communications, and 802.11b adapters for wireless network communications.

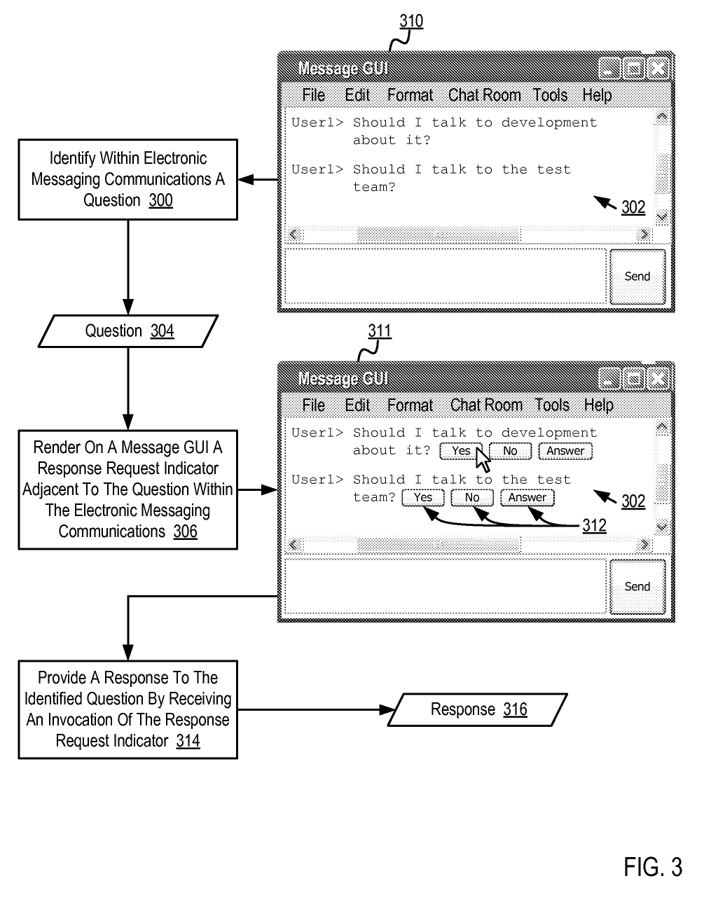

For further explanation, FIG. 3 sets forth a flow chart illustrating an exemplary method for disambiguating responses to questions within electronic messaging communications according to embodiments of the present invention. The method of FIG. 3 includes identifying (300) within electronic messaging communications (302) a question (304). As mentioned above, the electronic messaging communications (302) of FIG. 3 is a collection of related electronic messages employed for user communication. The electronic messaging communications (302) of FIG. 3 represents a conversation among users such as, for example, the chat messages exchanged in a chat room or the email messages of a thread of emails. The question (304) of FIG. 3 is an expression of inquiry by a user that invites or calls for a response.

The example of FIG. 3 also includes a message graphical user interface (‘GUI’) (310) that depicts an exemplary electronic messaging communications (302). The exemplary electronic messaging communications (302) of FIG. 3 is a collection of chat messages exchanged between users joined to a chat room. The message GUI (310) of FIG. 3 depicts ‘User1’ asking the following exemplary questions within the electronic messaging communications (302):

Should I talk to development about it?

Should I talk to the test team?

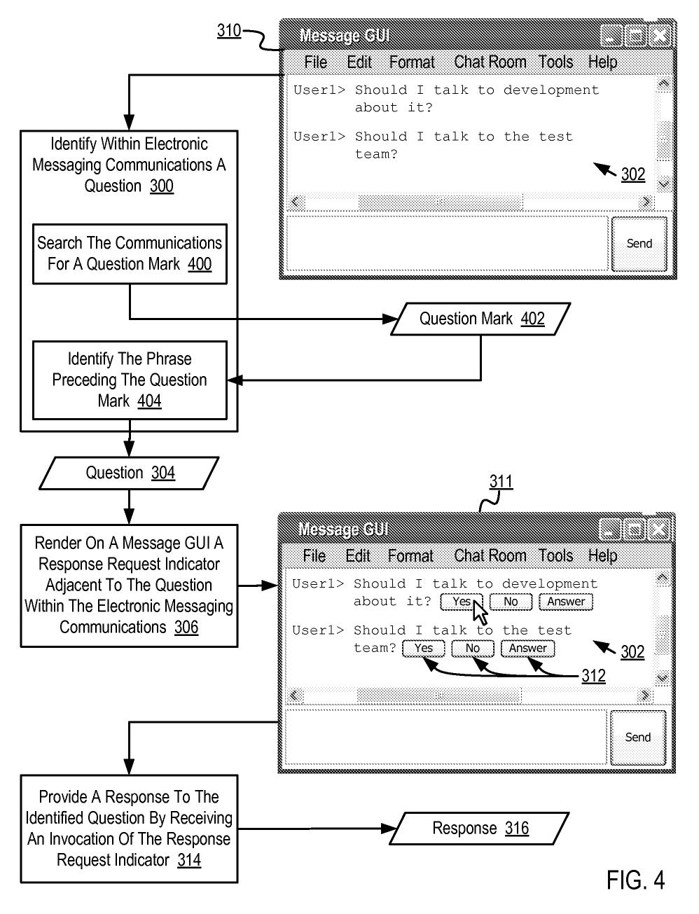

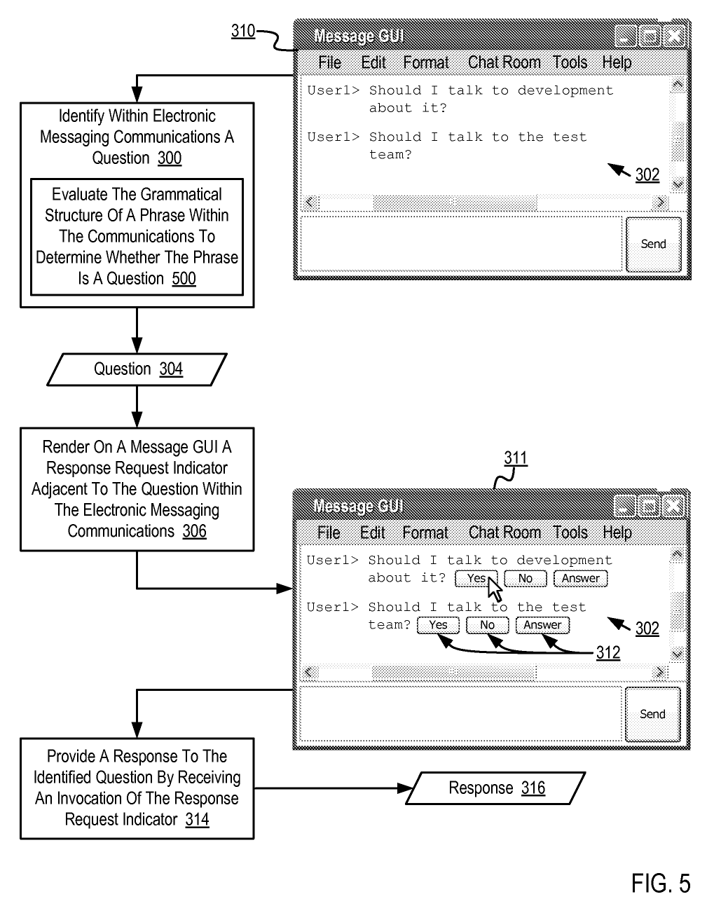

Both the exemplary questions described above invite a response from another user joined to the chat room depicted in the example of FIG. 3. Readers will note that the exemplary questions described above are for explanation and not for limitation in disambiguating responses to questions within electronic messaging communications according to embodiments of the present invention. In the example of FIG. 3, identifying (300) within the electronic messaging communications (302) a question (304) may be carried out by searching the communications (302) for a question mark and identifying the phrase preceding the question mark as discussed below with reference to FIG. 4. Identifying (300) within the electronic messaging communications (302) a question (304) according to the method of FIG. 3 may also be carried out by evaluating the grammatical structure of a phrase within the communications (302) to determine whether the phrase is a question (304) as discussed below with reference to FIG. 5. Evaluating the grammatical structure of a phrase within an electronic messaging communications (302) to determine whether the phrase is a question advantageously provides the ability to determine whether an electronic messaging communications has within it a question even when users do not provide punctuation marks in the messages.

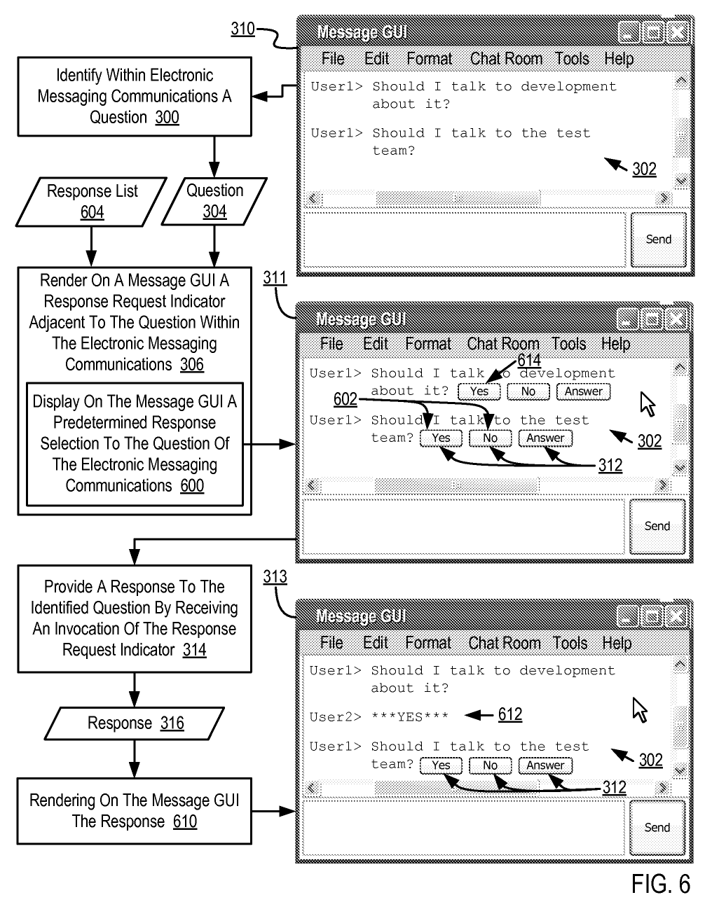

The method of FIG. 3 includes rendering (306) on the message GUI (310) a response request indicator (312) adjacent to a question (304) within the electronic messaging communications (302). A response request indictor (312) is a GUI element that indicates to a user that another user invites a response to a particular question and allows a user to associate a response with the particular question. In the method of FIG. 3, rendering (306) on the message GUI (310) a response request indicator (312) adjacent to a question (304) within the electronic messaging communications (302) may be carried out by displaying on the message GUI a predetermined response selection to the question of the electronic messaging communications (302) and displaying on the message GUI (310) a response input window as discussed below with reference to FIGS. 6, 7, and 8.

The example of FIG. 3 also includes a message GUI (311) on which a response request indicator (312) is rendered adjacent to a question (304) within the electronic messaging communications (302). The message GUI (311) is similar to the message GUI (310) in that the message GUI (311) displays the same two exemplary questions within the exemplary electronic messaging communications (302). The message GUI (311) of FIG. 3 differs from the message GUI (310) in that the message GUI (311) depicts three response request indicators (312) rendered adjacent to each of the two exemplary questions within the electronic messaging communications (302). The three response request indicators (312) are implemented as GUI buttons labeled ‘Yes,’ ‘No,’ and ‘Answer’ and described in more detail below. The response request indicators (312) advantageously provide a user with the ability to disambiguate responses to the two exemplary questions asked by ‘User1’ within the electronics messaging communications (302).

The method of FIG. 3 includes providing (314) a response (316) to the identified question (304) by receiving an invocation of the response request indicator (312). The response (316) is a user's reply to a question within electronic messaging communications. A response (316) may be implemented as an electronic message such as, for example, a chat message or an email message. Providing (314) a response (316) to the identified question (304) by receiving an invocation of the response request indicator (312) according to the method of FIG. 3 may be carried out by receiving a GUI notification from a GUI subsystem that a user selected the response request indicator (312) on a message GUI and creating an electronic response message embedded with a thread identifier associating the electronic response message with the electronic message containing the question (304). The electronic response message may be a chat message or an email message for transmission to an electronic messaging communications server using a data communications protocol such as, for example, Jabber, Internet Relay Chat (‘IRC’), Sametime, Simple Mail Transfer Protocol (‘SMTP’), Post Office Protocol (‘POP3’), and any other data communication protocols as will occur to those of skill in the art. The electronic messaging communications server may then make the electronic response message available to an electronic messaging communications client operated by a user asking the question (304).

As mentioned above, identifying within the electronic messaging communications a question may be carried out by searching the communications for a question mark and identifying the phrase preceding the question mark. For further explanation, therefore, FIG. 4 sets forth a flow chart illustrating a further exemplary method for disambiguating responses to questions within electronic messaging communications according to embodiments of the present invention that includes searching (400) the communications (302) for a question mark (402), and identifying (404) the phrase preceding the question mark (402).

The method of FIG. 4 is similar to the method of FIG. 3. That is, the method of FIG. 4 is similar to the method of FIG. 3 in that the method of FIG. 4 includes identifying (300) within electronic messaging communications (302) a question (304), rendering (306) on a message GUI (310) a response request indicator (312) adjacent to the question (304) within the electronic messaging communications (302), and providing (314) a response (316) to the identified question (304) by receiving an invocation of the response request indicator (312). The example of FIG. 4 is also similar to the example of FIG. 3 in that the example of FIG. 4 includes the question (304), the response (316), the message GUI (310) on which is rendered the electronic messaging communications (302), and the message GUI (311) on which is rendered the electronic messaging communications (302) and the response request indicators (312).

The method of FIG. 4 differs from the method of FIG. 3 in that identifying (300) within electronic messaging communications (302) a question (304) according to the method of FIG. 4 includes searching (400) the communications (302) for a question mark (402), and identifying (404) the phrase preceding the question mark (402). The question mark (402) is a punctuation symbol of a sentence or phrase to indicate that the sentence or phrase is a question. Question marks may be implemented differently from one language to another. For example, in English a question mark is implemented as a ‘?’ mark appended to the end of a sentence or phrase. In Spanish, question marks are implemented as a [symbol] mark and a ‘?’ mark appended to the beginning and the end of a sentence or phrase respectively. Readers will note that these exemplary question marks described above are for explanation and not for limitation. In fact, any punctuation symbol of a sentence or phrase indicating that the sentence or phrase is a question as will occur to those of skill in the art may be a question mark useful for disambiguating responses to questions within electronic messaging communications according to embodiments of the present invention.

In the method of FIG. 4, searching (400) the communications (302) for a question mark (402) may be carried out by traversing through the text of the electronic messages included in the electronic messaging communications (302) to identify a question mark (402). Consider, for example, the electronic messaging communications (302) rendered in the exemplary message GUI (310). Traversing through the characters of the electronic messages included in the electronic messaging communications (302) to identify a question mark (402) may be carried out by traversing through each chat message exchanged in the chat room displayed in the message GUI (310) to identify a ‘?’ mark in the text of the message.

In the method of FIG. 4, identifying (404) the phrase preceding the question mark (402) may be carried out by traversing through the text of the electronic message having a question mark (402) and locating the beginning of the phrase preceding the question mark. Locating the beginning of the phrase preceding the question mark may be carried out by identifying the end of phrase punctuation mark such as, for example, a period or an ellipse, that occurs before the question mark (402). In addition to utilizing punctuation marks, locating the beginning of the phrase preceding the question mark may also be carried out using grammatical structure, capitalization, or any other grammatical feature as will occur to those of skill in the art.

As mentioned above, identifying within the electronic messaging communications a question may be carried out by evaluating the grammatical structure of a phrase within the communications to determine whether the phrase is a question. For further explanation, therefore, FIG. 5 sets forth a flow chart illustrating a further exemplary method for disambiguating responses to questions within electronic messaging communications according to embodiments of the present invention that includes evaluating (500) the grammatical structure of a phrase within the communications (302) to determine whether the phrase is a question (304).

The method of FIG. 5 is similar to the method of FIG. 3. That is, the method of FIG. 5 is similar to the method of FIG. 3 in that the method of FIG. 5 includes identifying (300) within electronic messaging communications (302) a question (304), rendering (306) on a message GUI (310) a response request indicator (312) adjacent to the question (304) within the electronic messaging communications (302), and providing (314) a response (316) to the identified question (304) by receiving an invocation of the response request indicator (312). The example of FIG. 5 is also similar to the example of FIG. 3 in that the example of FIG. 5 includes the question (304), the response (316), the message GUI (310) on which is rendered the electronic messaging communications (302), and the message GUI (311) on which is rendered the electronic messaging communications (302) and the response request indicators (312).

The method of FIG. 5 differs from the method of FIG. 3 in that identifying (300) within electronic messaging communications (302) a question (304) according to the method of FIG. 5 includes evaluating (500) the grammatical structure of a phrase within the communications (302) to determine whether the phrase is a question (304). Evaluating (500) the grammatical structure of a phrase within the communications (302) to determine whether the phrase is a question (304) may be carried out by identifying particular keywords such as, for example, ‘who,’ ‘what,’ ‘when,’ ‘where,’ ‘how,’ and so on. Evaluating (500) the grammatical structure of a phrase within the communications (302) to determine whether the phrase is a question (304) according to the method of FIG. 5 may also be carried out by identifying auxiliary verbs of a phrase repeated near the end of the phrase in the negative form such as, for example, “You will come, won't you?” Evaluating (500) the grammatical structure of a phrase within the communications (302) to determine whether the phrase is a question (304) according to the method of FIG. 5 may also be carried out by identifying a phrase in which a verb occurs immediately before a noun such as, for example, “Can we meet tomorrow?” Readers will note that carrying out evaluating (500) the grammatical structure of a phrase within the communications (302) to determine whether the phrase is a question (304) as described above is for explanation and not for limitation. In fact, evaluating (500) the grammatical structure of a phrase within the communications (302) to determine whether the phrase is a question (304) according to embodiments of the present invention may be carried out in other ways as will occur to those of skill in the art.

As mentioned above, rendering on the message GUI a response request indicator adjacent to a question within the electronic messaging communications may be carried out by displaying on the message GUI a predetermined response selection to the question of the electronic messaging communications. For further explanation, therefore, FIG. 6 sets forth a flow chart illustrating a further exemplary method for disambiguating responses to questions within electronic messaging communications according to embodiments of the present invention that includes displaying (600) on the message GUI (310) a predetermined response selection (602) to the question (304) of the electronic messaging communications (302).

The method of FIG. 6 is similar to the method of FIG. 3. That is, the method of FIG. 6 is similar to the method of FIG. 3 in that the method of FIG. 6 includes identifying (300) within electronic messaging communications (302) a question (304), rendering (306) on a message GUI (310) a response request indicator (312) adjacent to the question (304) within the electronic messaging communications (302), and providing (314) a response (316) to the identified question (304) by receiving an invocation of the response request indicator (312). The example of FIG. 6 is also similar to the example of FIG. 3 in that the example of FIG. 6 includes the question (304), the response (316), the message GUI (310) on which is rendered the electronic messaging communications (302), and the message GUI (311) on which is rendered the electronic messaging communications (302) and the response request indicators (312).

The method of FIG. 6 differs from the method of FIG. 3 in that rendering (306) on a message GUI (310) a response request indicator (312) adjacent to the question (304) within the electronic messaging communications (302) according to the method of FIG. 6 includes displaying (600) on the message GUI (310) a predetermined response selection (602) to the question (304) of the electronic messaging communications (302). The predetermined response selection (602) is a response request indicator (312) that allows a user to associate a predetermined user response with a particular question within an electronic messaging communications. A predetermined user response is a response that users commonly utilize in responding to questions. Examples of predetermined user responses may include ‘yes,’ ‘no,’ ‘maybe,’ and so on. In the example of FIG. 6, displaying (600) on the message GUI (310) a predetermined response selection (602) to the question (304) of the electronic messaging communications (302) may be carried out by retrieving a predetermined user response from a user response list (604) and rendering the predetermined response selection (602) for the predetermined user response.

The method of FIG. 6 also includes rendering (610) on the message GUI (310) the response (316). Rendering (610) on the message GUI (310) the response (316) according to the method of FIG. 6 may be carried out by inserting the response (316) to the identified question (304) on the message GUI (310) directly beneath the location on the message GUI (310) of the identified question (304). Rendering (610) on the message GUI (310) the response (316) according to the method of FIG. 6 may also be carried out by adding the identified question (304) and the response (316) to the message GUI (310) beneath the most recent message of the electronic messaging communications (302) near the bottom of the message GUI (310). Inserting the response (316) to the identified question (304) on the message GUI (310) directly beneath the location on the message GUI (310) of the identified question (304) and adding the identified question (304) and the response (316) to the message GUI (310) beneath the most recent message of the electronic messaging communications (302) advantageously disambiguates the response to a question when more than one question occurs in electronic messaging communications.

Whether rendering (610) the response (316) on the message GUI (310) may be carried out by inserting the response (316) directly beneath the identified question (304) or by adding the identified question (304) and the response (316) beneath the most recent message of the communications (302) may depend on user preferences. Consider, for example, a user exchanging chat messages in a chat client operating according to embodiments of the present invention. The user may prefer not to have his or her train of thought interrupted with a response to a question that was asked by another user twenty chat messages prior to the most recent message. In many cases, such a message may have already scrolled off the message GUI. Such a user may set a preference such that rendering (610) the response (316) on the message GUI (310) according to the method of FIG. 6 may be carried out by inserting the response (316) directly beneath the original location of the identified question (304) on the GUI instead of below the most recent chat message. Other users may, however, prefer to be interrupted when a response to a question arrives. Such a user may set a preference in order that rendering (610) the response (316) on the message GUI (310) according to the method of FIG. 6 may be carried out by adding the identified question (304) and the response (316) beneath the most recent message of the communications (302) instead of inserting the response (316) directly beneath the original location on the GUI of the identified question (304).

The example of FIG. 6 includes a message GUI (313) on which the response (316) is rendered. The message GUI (313) is similar to the message GUIs (310, 311) in that the message GUI (313) displays the same two exemplary questions within the exemplary electronic messaging communications (302) and depicts three response request indicators (312) rendered adjacent to the second exemplary question within the electronic messaging communications (302). The message GUI (313) of FIG. 6 differs from the message GUIs (310, 311) in that the message GUI (313) depicts a response (316) rendered as ‘***YES***’ (612) inserted directly beneath the location on the message GUI (313) of the first exemplary question of the communications (302). FIG. 6 depicts the ‘***YES***’ (612) on the message GUI (313) in response to a user operating the ‘Yes’ (614) response request indicator rendered on the message GUI (311) depicted in FIG. 6. After a user operates a response request indicator such as, for example, the ‘Yes’ button (614) of message GUI (311), the response request indicators rendered adjacent to a particular question are typically no longer needed by the user and may be removed from a GUI such as, for example, the message GUI (313) of FIG. 6 for the exemplary question ‘Should I talk to development about it?’

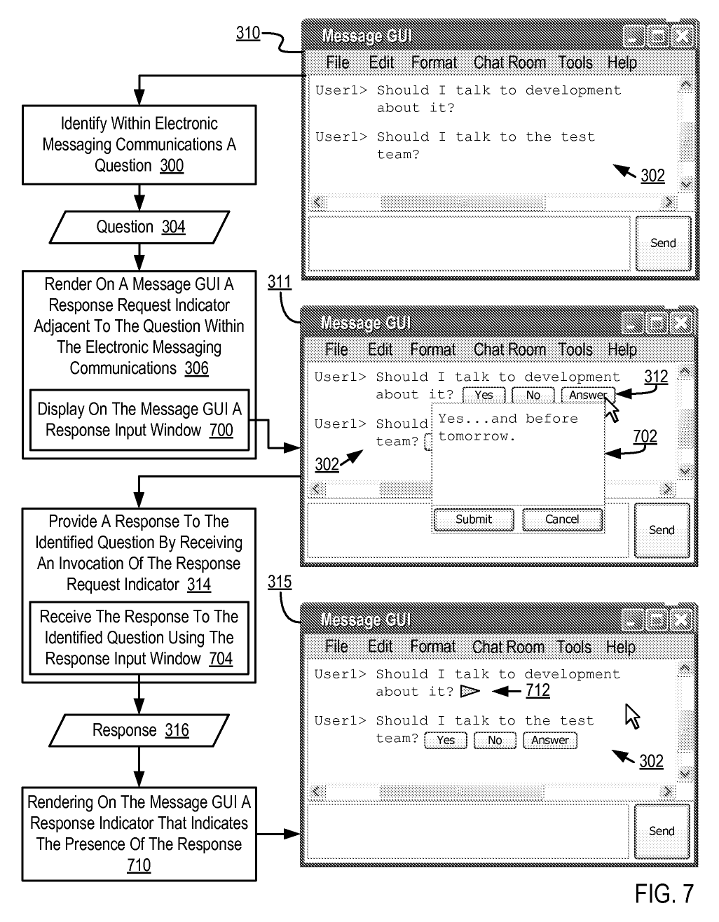

As mentioned above, rendering on the message GUI a response request indicator adjacent to a question within the electronic messaging communications may be carried out by displaying on the message GUI a response input window. For further explanation, therefore, FIG. 7 sets forth a flow chart illustrating a further exemplary method for disambiguating responses to questions within electronic messaging communications according to embodiments of the present invention that includes displaying (700) on the message GUI (310) a response input window.

The method of FIG. 7 is similar to the method of FIG. 3. That is, the method of FIG. 7 is similar to the method of FIG. 3 in that the method of FIG. 7 includes identifying (300) within electronic messaging communications (302) a question (304), rendering (306) on a message GUI (310) a response request indicator (312) adjacent to the question (304) within the electronic messaging communications (302), and providing (314) a response (316) to the identified question (304) by receiving an invocation of the response request indicator (312). The example of FIG. 7 is also similar to the example of FIG. 3 in that the example of FIG. 7 includes the question (304), the response (316), the message GUI (310) on which is rendered the electronic messaging communications (302), and the message GUI (311) on which is rendered the electronic messaging communications (302) and the response request indicators (312).

The method of FIG. 7 differs from the method of FIG. 3 in that rendering (306) on a message GUI (310) a response request indicator (312) adjacent to the question (304) within the electronic messaging communications (302) according to the method of FIG. 7 includes displaying (700) on the message GUI (310) a response input window (702). The response input window (702) is a text box in which a user may type a response to a particular question within the electronic messaging communications (302). The response input widows (702) provides a user with the capability of typing a customized response to the question instead of relying on a predetermined user response as described above with reference to FIG. 6.

In the method of FIG. 7, displaying (700) on the message GUI (310) a response input window (702) may be carried out by rendering a text box on the message GUI (310) when the user operates a response request indicator (312) rendered on the message GUI (310). FIG. 7 illustrates an exemplary response input window (702) displayed on the exemplary message GUI (311) when a user clicks on the response request indicator (712) labeled ‘Answer.’ The response input window (702) includes a text area for a user to type a response to a particular question of the electronic messaging communications (302). In addition, the response input window (702) includes a ‘submit’ button and a ‘cancel’ button for a user send the response or to cancel the response respectively.

In the method of FIG. 7, providing (314) a response (316) to the identified question (304) by receiving an invocation of the response request indicator (312) includes receiving (704) the response to the identified question (304) using the response input window (702). Receiving (704) the response to the identified question (304) using the response input window (702) may be carried out by displaying a response input window (702) when a user selects a response request indicator (312) such as, for example, the response request indicator labeled ‘Answer.’ Receiving (704) the response to the identified question (304) using the response input window (702) may further be carried out by receiving a GUI notification that a user selected the ‘Submit’ button of the response input window (702) receiving from the GUI notification subsystem the text or a pointer to the text provided by the user through the response input window (702). In the exemplary message GUI (311) illustrated in FIG. 7, the user provides the text “Yes . . . and before tomorrow.” as a response to the question “Should I talked to development about it?”

The method of FIG. 7 also includes rendering (710) on the message GUI (310) a response indicator (712) that indicates the presence of the response (316). The response indicator (712) is a GUI element that indicates to users that one of the users has provided a response to a particular question within the electronic messaging communications. The message GUI (315) of FIG. 7 illustrates a response indicator (712) that indicates the presence of the response (316). Because a response to a question may be quite long, rendering (700) the response indicator (712) instead of the actual response (316) advantageously alerts users viewing a message GUI that a response has been provided without significantly affecting the visual appearance of the message GUI in a manner that might distract users.

Rendering (710) on the message GUI a response indicator (712) that indicates the presence of the response (316) may be carried out by appending the response indicator (712) to the end of the identified question (304) on the message GUI (310). Rendering (710) on the message GUI a response indicator (712) that indicates the presence of the response (316) may be carried out by adding the identified question (304) with the response indicator (712) appended to the end of the identified question (304) on the message GUI (310) beneath the most recent message in the electronic messaging communications (302). Appending the response indicator (712) to the end of the identified question (304) and adding the identified question (304) with the response indicator (712) appended to the end of the identified question (304) on the message GUI (310) beneath the most recent message in the electronic messaging communications (302) advantageously disambiguates the response to a question when more than one question occurs in electronic messaging communications. Whether rendering (710) a response indicator (712) on the message GUI may be carried out by appending the response indicator (712) to the end of the identified question (304) or by adding the identified question (304) with the response indicator (712) appended to the end of the identified question (304) beneath the most recent message in the electronic messaging communications (302) on the message GUI (310) may depend on user preferences as discussed above with reference to FIG. 6.

FIG. 7 illustrates an exemplary message GUI (315) on which a response indicator (712) is rendered. In the exemplary message GUI (315), the response indicator (712) is depicted as a triangle at the end of the question “Should I talk to development about it?” Such a triangle shaped response indicator (712) is often referred to as a ‘twistie.’ The triangle shaped response indicator (712) of FIG. 7 is so called because the response indicator (712) of FIG. 7 ‘twists’ ninety degrees clockwise when selected by a user to reveal the actual response (316) to the question. When a user selects the response indicator (712) for a second time to hide the response (316), the response indicator (712) returns to the original position depicted in FIG. 7 by twisting ninety degrees counter-clockwise. Rendering (710) a response indicator (712) on a message GUI according to the method of FIG. 7, therefore, advantageously provides a user the ability to hide long and unwieldy responses while disambiguating responses to questions within electronic messaging communications according to embodiments of the present invention.

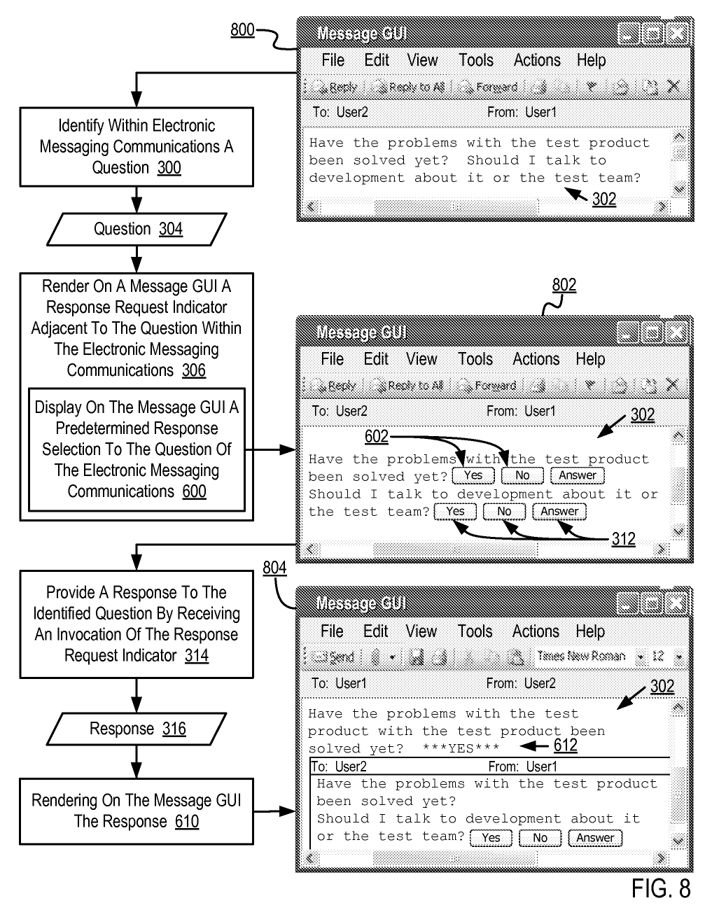

Readers will note that FIGS. 3-7 illustrate electronic messaging communications as chat messages exchanged in a chat room. As mentioned above, electronic messaging communications may also be implemented as the email messages of a thread of emails. For further explanation, therefore, FIG. 8 sets forth a flow chart illustrating a further exemplary method for disambiguating responses to questions within electronic messaging communications according to embodiments of the present invention in which the electronic messaging communications (302) is implemented as the email messages of a thread of emails.

The method of FIG. 8 is similar to the method of FIG. 6. That is, the method of FIG. 8 is similar to the method of FIG. 6 in that the method of FIG. 8 includes identifying (300) within electronic messaging communications (302) a question (304), rendering (306) on a message GUI a response request indicator (312) adjacent to the question (304) within the electronic messaging communications (302), displaying (600) on the message GUI a predetermined response selection (602) to the question of the electronic messaging communications (302), providing (314) a response (316) to the identified question (304) by receiving an invocation of the response request indicator (312), and rendering (610) on the message GUI the response. The example of FIG. 8 is similar to the example of FIG. 6 in that the example of FIG. 8 includes: the question (304); the response (316); a message GUI (800) on which is rendered the electronic messaging communications (302); a message GUI (802) on which is rendered the electronic messaging communications (302), response request indicators (312), and predetermined response selections (602); and a message GUI (804) on which is rendered the electronic messaging communications (302) and a rendered response (612).

The example of FIG. 8 differs from the example of FIG. 6 in that the electronic messaging communications (302) of FIG. 8 is implemented as the email messages of a thread of emails. The message GUI (800) illustrated in FIG. 8 depicts an email from ‘User1’ to ‘User2’ asking the following exemplary questions in the body of an email: “Have the problems with the test product been solved yet? Should I talk to the development team about it or the test team?”

The message GUI (802) illustrated in FIG. 8 depicts the same exemplary questions in the electronic messaging communications (302) of the message GUI (802). The message GUI (802) includes three response indicators (312) labeled ‘Yes,’ ‘No,’ and ‘Answer’ rendered adjacent to each of the exemplary questions. The response request indicators (312) labeled ‘Yes’ and ‘No’ are predetermined response selections (602) that provide user responses to the exemplary questions within the electronic messaging communications (302).

Readers will note that when electronic messaging communications are implemented as the email messages of a thread of emails, the responses to the questions in an email are typically implemented as reply email messages to the sender of the email containing the question. When a user operates a response request indicator such as, for example, the response request indicators (312) depicted in message GUI (802), providing (314) a response (316) to the identified question (304) by receiving an invocation of the response request indicator (312) may be carried out by creating an new response email message that includes the original email containing the particular question to which a user is responding.

The message GUI (804) illustrated in FIG. 8 depicts a response email message that includes the original email containing the particular question to which a user is responding. Because the reply email message belongs to the same thread of emails as the original email message having the question, the electronic messaging communications depicted in the message GUI (804) includes both email messages. The message GUI (804) illustrated in FIG. 8 depicts the first exemplary question from the original email reproduced in the reply email message along with the response (316) rendered as the phrase ‘***YES***’ (612). Rendering the response (316) along with the identified question (304) in the reply email message advantageously disambiguate responses to questions within the electronic messaging communications (302). Readers will note that a user has not responded to the second exemplary question within the electronic messaging communications (302). As such, the response request indicators labeled ‘Yes,’ ‘No,’ and ‘Answer’ rendered adjacent to the second exemplary question remain displayed on the message GUI (804) to provide a user the capability of disambiguating responses to questions within the electronic messaging communications (302) using the same reply email message.

Exemplary embodiments of the present invention are described largely in the context of a fully functional computer system for disambiguating responses to questions within electronic messaging communications. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for disambiguating responses to questions within electronic messaging communications, the method comprising:
identifying within electronic messaging communications a question;
rendering on a message graphical user interface (‘GUI’) a response request indicator adjacent to the question within the electronic messaging communications; and
providing a response to the identified question by receiving an invocation of the response request indicator.

2. The method of claim 1 further comprising rendering on the message GUI the response.

3. The method of claim 1 further comprising rendering on the message GUI a response indicator that indicates the presence of the response.

4. The method of claim 1 wherein identifying within the electronic messaging communications the question further comprises:
searching the communications for a question mark; and
identifying the phrase preceding the question mark.

5. The method of claim 1 wherein identifying within the electronic messaging communications the question further comprises evaluating the grammatical structure of a phrase within the communications to determine whether the phrase is a question.

6. The method of claim 1 wherein rendering on the message GUI the response request indicator further comprises displaying on the message GUI a predetermined response selection to the question of the electronic messaging communications.

7. The method of claim 1 wherein:
rendering on the message GUI the response request indicator further comprises displaying on the message GUI a response input window; and
providing a response to the identified question by receiving an invocation of the response request indicator further comprises receiving the response to the identified question using the response input window.

8. An apparatus for disambiguating responses to questions within electronic messaging communications, the apparatus comprising a computer processor, a computer memory operatively coupled to the computer processor, the computer memory having disposed within it computer program instructions capable of:
identifying within electronic messaging communications a question;
rendering on a message graphical user interface (‘GUI’) a response request indicator adjacent to the question within the electronic messaging communications; and
providing a response to the identified question by receiving an invocation of the response request indicator.

9. The apparatus of claim 8 further comprising computer program instructions capable of rendering on the message GUI the response.

10. The apparatus of claim 8 further comprising computer program instructions capable of rendering on the message GUI a response indicator that indicates the presence of the response.

11. The apparatus of claim 8 wherein rendering on the message GUI the response request indicator further comprises displaying on the message GUI a predetermined response selection to the question of the electronic messaging communications.

12. The apparatus of claim 8 wherein:
rendering on the message GUI the response request indicator further comprises displaying on the message GUI a response input window; and
providing a response to the identified question by receiving an invocation of the response request indicator further comprises receiving the response to the identified question using the response input window.

13. A computer program product for disambiguating responses to questions within electronic messaging communications, the computer program product disposed upon a signal bearing medium, the computer program product comprising computer program instructions capable of:
identifying within electronic messaging communications a question;
rendering on a message graphical user interface (‘GUI’) a response request indicator adjacent to the question within the electronic messaging communications; and
providing a response to the identified question by receiving an invocation of the response request indicator.

14. The computer program product of claim 13 wherein the signal bearing medium comprises a recordable medium.

15. The computer program product of claim 13 wherein the signal bearing medium comprises a transmission medium.

16. The computer program product of claim 13 further comprising computer program instructions capable of rendering on the message GUI the response.

17. The computer program product of claim 13 further comprising computer program instructions capable of rendering on the message GUI a response indicator that indicates the presence of the response.

18. The computer program product of claim 13 wherein identifying within the electronic messaging communications the question further comprises:
searching the communications for a question mark; and
identifying the phrase preceding the question mark.

19. The computer program product of claim 13 wherein rendering on the message GUI the response request indicator further comprises displaying on the message GUI a predetermined response selection to the question of the electronic messaging communications.

20. The computer program product of claim 13 wherein:
rendering on the message GUI the response request indicator further comprises displaying on the message GUI a response input window; and
providing a response to the identified question by receiving an invocation of the response request indicator further comprises receiving the response to the identified question using the response input window.
